(19) United States
(12) Patent Application Publication
(10) Pub. No.: US 2010/0227054 A1
(43) Pub. Date: Sep. 9, 2010

(54) METHOD OF MANUFACTURING POLARIZATION ELEMENT

(75) Inventor: Yoshitomo KUMAI, Okaya (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/696,502

(22) Filed: Jan. 29, 2010

(30) Foreign Application Priority Data
Mar. 6, 2009 (JP) 2009-054119

(51) Int. Cl. B05D 5/06

(52) U.S. Cl. 427/163.1

(57) ABSTRACT

A method of manufacturing a polarization element, adapted to form a film at least on a part of a surface of a plurality of convex sections provided to at least one surface of the substrate, includes: (a) depositing a first film material on the one surface of the substrate in a first direction to thereby form a first film on the convex section; and (b) depositing a second film material in a second direction different from the first direction to thereby form a second film on the convex section.

The entire disclosure of Japanese Patent Application No: 2009-054119, filed Mar. 6, 2009 is expressly incorporated by reference herein.

### BACKGROUND

1. Technical Field

The present invention relates to a method of manufacturing a polarization element.

2. Related Art

As light modulation devices of various types of electro-optic devices, there are used liquid crystal devices. As a structure of the liquid crystal device, there is widely known a structure in which the liquid crystal layer is sandwiched between a pair of substrates disposed so as to be opposed to each other, and a polarization element for inputting the light with predetermined polarization into the liquid crystal layer and an oriented film for controlling the arrangement of the liquid crystal molecules when no voltage is applied thereto are typically provided.

As the polarization element, there are known a film type polarization element manufactured by stretching a resin film including iodine or dichroic dye in one direction thereby orienting the iodine or the dichroic dye in the stretching direction, and a wire-grid type polarization element formed by paving the surface of a transparent substrate with nano-scale thin lines.

The wire-grid type polarization element is made of an inorganic material, and therefore, has an advantage of being superior in heat resistance, and is preferably used in a place where heat resistance is particularly required. For example, it is preferably used as a polarization element for a light valve of a liquid crystal projector. As such a wire-grid type polarization element as described above, there is disclosed a technology described in JP-A-2008-216957 (Document 1), for example.

In the Document 1, a metallic material is deposited using an oblique sputtering method executed in a tilted direction on concavo-convex portions formed on the substrate, and the metal microparticulate layer thus deposited is used as the thin lines, instead of using the related art method of forming the thin lines by patterning the metal film by etching. According to the Document 1, this method can provide a polarization plate having a desired extinction ratio in the visible light range and light-resistance property against intensive light.

However, in the manufacturing method of the polarization element of the related art described above, there arises a problem that when the thin lines are formed at the convex portions on the substrate by executing the oblique sputtering, unevenness is caused in the amount of deposition of the metallic particles as a material of the thin lines depending on the position in the surface of the substrate. In other words, in the method described in the Document 1, the distance from the material source of the metallic material varies in accordance with the position on the surface of the substrate. Therefore, there arises unevenness of about ±50% of the target size in each of the metallic materials deposited thereon depending on the position on the surface of the substrate. If the unevenness is caused in the size of the metallic material, the parameters closely related to the optical solid state properties of the polarization element, such as the distance between the adjacent thin lines, or the width or the height of the thin line vary, and therefore, it is not achievable to express the uniform optical solid state properties throughout the entire polarization element.

### SUMMARY

An advantage of some aspects of the invention is to provide a manufacturing method of a polarization element capable of manufacturing a polarization element expressing optical solid state properties more uniform than those in the related art.

An aspect of the invention is directed to a method of manufacturing a polarization element, adapted to form a film at least on apart of a surface of a plurality of convex sections provided to at least one surface of the substrate, the method including the steps of (a) depositing a first film material on the one surface of the substrate in a first direction to thereby form a first film on the convex section, and (b) depositing a second film material in a second direction different from the first direction to thereby form a second film on the convex section.

According to this aspect of the invention, it is possible to make the unevenness in the film thickness of the first film and the unevenness in the film thickness of the second film different from each other, and to cancel the unevenness in thickness of the first film with the unevenness in thickness of the second film.

In other words, when forming the first film, there is caused the unevenness in the amount of deposition of the first film material deposited on each of the convex sections depending on the locations of the convex sections in the surface of the substrate. Thus, the unevenness in the film thickness of the first films formed on the surface of each of the convex sections is caused therefrom. However, by depositing the second film material on each of the convex sections in the second direction different from the first direction in which the first film material is deposited thereon after forming the first film, the second films having the unevenness in film thickness different from the unevenness in film thickness of the first film are formed on the surface of each of the convex sections. Therefore, it becomes possible to cancel the unevenness of the film thickness of the first film with the unevenness of the film thickness of the second film to thereby uniformize the film thickness of the film composed of the first film and the second film.

Therefore, it becomes possible to form the films with uniform film thickness composed of the first films and the second films on the surfaces of the convex sections, respectively, to thereby manufacture the polarization element expressing the optical solid state properties more uniform than those in the related art.

Further, according to another aspect of the invention, in the method of manufacturing a polarization element according to the above aspect of the invention, the plurality of convex sections is disposed in a striped manner, and the first direction and the second direction intersect with an extending direction of the convex sections.

According to this aspect of the invention, it is possible to deposit the first film material and the second film material from either one of the both side surfaces disposed in the direction along the shorter dimension of the convex sections disposed so as to form stripes. Thus, it becomes possible to form the film shaped like a thin line composed of the first film and the second film on the surface of each of the convex sections arranged in a striped manner.

Further, according to still another aspect of the invention, in the method of manufacturing a polarization element according to the above aspect of the invention, the first direction is a direction traversing the convex section from one side surface of both of side surfaces of the convex section in a direction along a shorter dimension of the convex section to the other side surface, and the second direction is a direction traversing the convex section from the other side surface to the one side surface.

According to this aspect of the invention, it is possible to form the first film and the second film on the respective side surfaces of each of the convex sections in the direction along the shorter dimension of the convex section. Further, in the direction intersecting with the extending direction of the convex sections, the gradient of the variation in the film thickness of the first films at respective locations on the substrate becomes opposite to the gradient of the variation in the film thickness of the second films at the respective locations on the substrate.

Further, according to yet another aspect of the invention, in the method of manufacturing a polarization element according to the above aspect of the invention, there is further provided (c) reversing the substrate, and step (c) is performed between steps (a) and (b).

According to this aspect of the invention, it becomes possible to dispose the first film material and the second film material on the same side (in substantially the same direction) with respect to the substrate, to deposit the first film material and the second film material on the convex sections in the directions opposite to each other to thereby form the first films and the second films in the direction different from each other.

### BRIEF DESCRIPTION OF THE DRAWINGS

The invention will now be described with reference to the accompanying drawings, wherein like numbers reference like elements.

FIG. 1 is an explanatory diagram showing an example of film forming device according to an embodiment of the invention.

FIGS. 2A through 2C are cross-sectional process charts showing a manufacturing process of the polarization element according to the embodiment of the invention.

FIGS. 3A and 3B are cross-sectional process charts showing the same.

FIG. 4 is a schematic diagram showing an example of the polarization element according to the embodiment of the invention.

FIG. 5 is an explanatory diagram related to uniformization of the film thickness of the film provided to the polarization element.

FIG. 6 is an explanatory diagram of the same.

FIG. 7 is an explanatory diagram of the same.

FIG. 8 is an explanatory diagram of the same.

FIG. 9 is an explanatory diagram of the same.

FIG. 10 is an explanatory diagram of the same.

FIG. 11 is an explanatory diagram of the same.

FIG. 12 is an explanatory diagram of the same.

FIG. 13 is a graph showing the variation in film thickness of the film provided to the polarization element.

FIG. 14 is a diagram showing the positional relationship between a substrate and a material source of a film material.

FIG. 15 is an explanatory diagram of measurement points of the film thickness.

FIG. 16 is a graph showing a result of the measurement of the film thickness.

FIG. 17 is a graph showing a standardized result of the measurement of the film thickness.

FIG. 18 is a graph showing a relationship between the variation of the film thickness, and the angle of the substrate and the deposition rate.

### DESCRIPTION OF AN EXEMPLARY EMBODIMENT

A method of manufacturing a polarization element according to an embodiment of the invention will hereinafter be described with reference to the accompanying drawings.

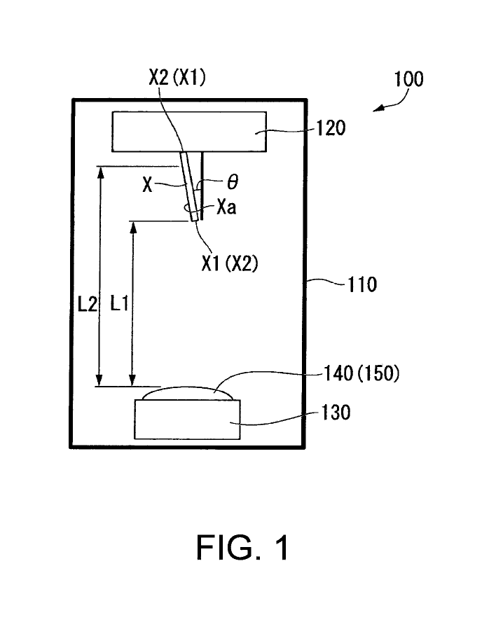

FIG. 1 is a schematic diagram of an evaporation apparatus as an example of a manufacturing apparatus used for the method of manufacturing the polarization element according to the present embodiment.

As shown in FIG. 1, the evaporation apparatus 100 is provided with a chamber 110, a mounting stage 120 disposed inside the chamber 110 and for mounting a target substrate X to be processed, a crucible 130 disposed to be opposed to the mounting stage 120, and a film material 140 disposed in the crucible 130. In the evaporation apparatus 100, the target substrate X is mounted on the mounting stage 120 in the state of being tilted an angle θ with respect to the direction of the normal line (the normal line passing through the center of the film material 140) of the surface of the mounting stage 120, and the film material 140 inside the crucible 130 is evaporated to thereby perform the evaporation on the target substrate X. The target substrate X is previously provided with a plurality of convex sections on a film forming surface Xa, and then mounted on the mounting stage 120. The film forming surface Xa of the target substrate X can be either one of the surfaces of the target substrate X, or both of the surfaces of the target substrate X.

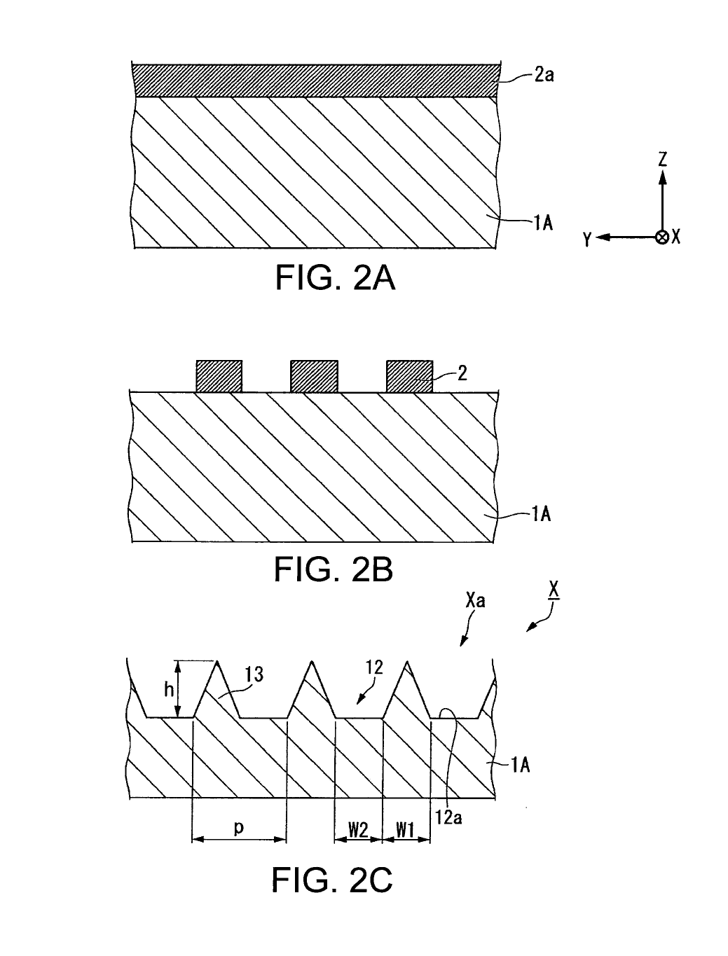

Then, the process of providing the convex sections to the film forming surface Xa of the target substrate X. FIGS. 2A through 2C are explanatory diagrams showing the process of providing the plurality of convex sections to the target substrate X.

Firstly, as shown in FIG. 2A, a substrate 1A formed of, for example, a glass substrate is prepared. Then, one of the surfaces of the substrate 1A is coated with a resist material using a spin coating method, and then the resist material thus coated is pre-baked to thereby form a resist layer 2a. As the resist material, there is used, for example, a chemically-amplified positive photoresist TDUR-P338EM (produced by Tokyo Ohka Kogyo Co., Ltd.). In the present embodiment, the resist layer 2a is formed to have a thickness of about 200 nm.

Subsequently, as shown in FIG. 2B, the resist layer 2a is exposed by a two-beam interference exposure method using laser beams with a wavelength of, for example, 266 nm as the exposure light beams. Further, the resist layer 2a is baked (PEB), and then the resist layer 2a is developed. Thus, the resist 2 having a striped pattern is formed. The height of the resist 2 of the present embodiment is 200 nm.

Subsequently, as shown in FIG. 2C, a dry etching process is performed thereon via the resist 2 to thereby dig in the substrate 1A as deep as about 50 through 300 nm. Thus, the substrate 1A is patterned to thereby form the target substrate X having concave sections 12 and the convex sections 13. In the present embodiment, the etching process is performed until the concave sections 12 have a depth of 100 nm. Further, a mixed gas of C₂F₆, CF₄, and CHF₃ is used as the etching gas. The etching is performed with the reaction conditions in which the gas flow rates of C₂F₆, CF₄, and CHF₃ are 20, 30, and 30 sccm, respectively, the discharge output is 300 W, the pressure is 5 Pa, and the reaction time is in a range of 30 through 40 sec.

Through the process described above, the plurality of concave sections 12 and the plurality of convex sections 13 are provided to the film forming surface Xa of the target substrate X.

The convex section 13 provided to the film forming surface Xa of the target substrate X can be formed to have various shapes in accordance with the polarization element to be manufactured. For example, it can be formed to have a cross-sectional shape such as a rectangular shape, a semicircular shape, a semielliptical shape, or a parabolic shape, besides the triangular cross-sectional shape shown in FIG. 2C. Further, the convex section 13 can be formed to have a shape such as a cylindrical shape, a rectangular solid shape, a cubic shape, a conical shape, a polygonal pyramid shape, a hemispherical shape, a semi-spheroidal shape, or a mortar-like shape. Further, it is also possible to arrange these convex sections on the film forming surface Xa of the target substrate X in a zigzag manner, or the closest packing manner, or with predetermined intervals in a predetermined direction. Further, it is also possible to make the convex sections 13 having the cross-sectional shape described above extend in one direction to form convex line sections, and arrange the convex line sections with predetermined intervals to form stripes.

In the present embodiment, as shown in FIG. 2C, the convex sections 13 are each formed to have a triangular cross-sectional shape, and formed like a convex line extending in a direction perpendicular to the cross-section shown in the drawing. Further, the concave sections 12 are each formed like a concave line extending in a direction perpendicular to the cross-section in the same manner. Further, the convex sections 13 are arranged in a cross-sectional direction with predetermined intervals to form stripes. The dimensions of the convex sections 13 and the concave sections 12 in the cross-section substantially perpendicular to the extending direction of the convex sections 13 are, for example, as follows. The height h of the convex sections 13 is 100 nm, the width W1 of each of the convex sections 13 is 70 nm, the width W2 of each of the bottom surfaces 12a is 70 nm, and the pitch p of the convex sections 13 is 140 nm.

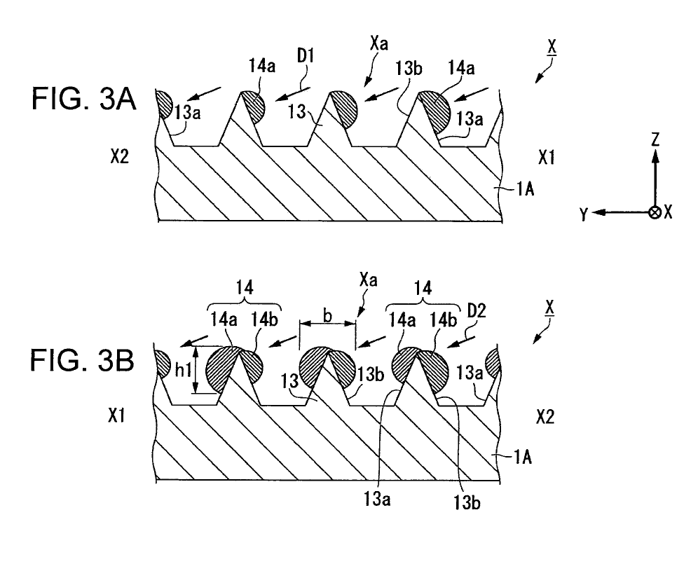

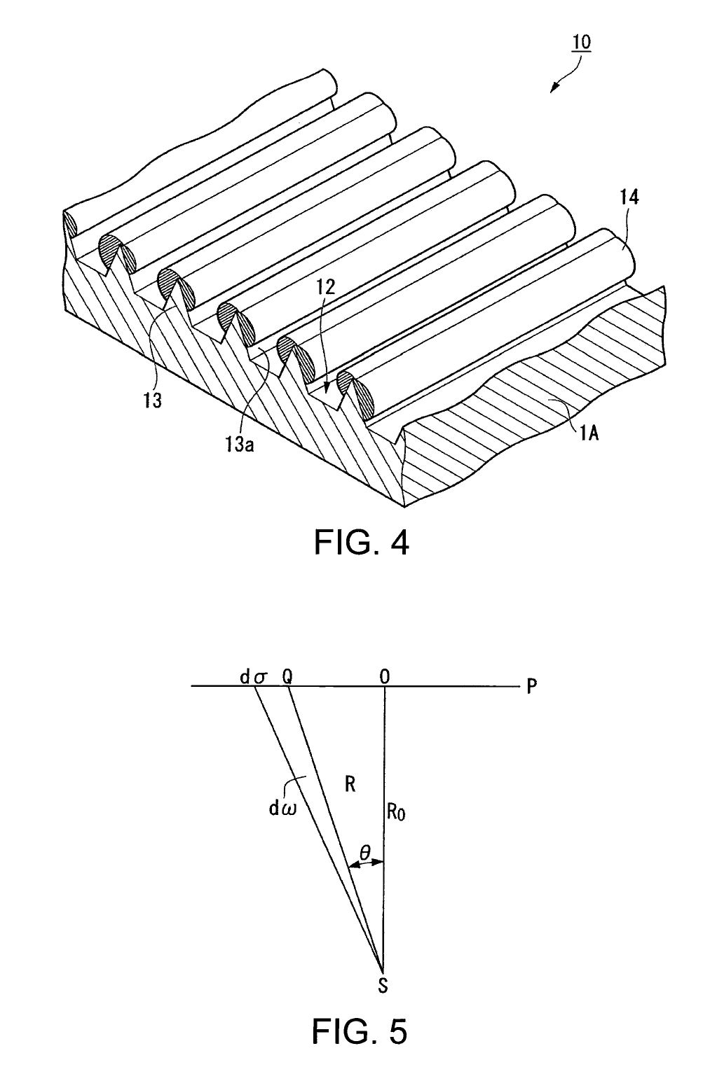

Then, the process of providing a film 14 to the convex sections 13 of the film forming surface Xa by depositing particles of the film material 140 on the film forming surface Xa of the target substrate X will be explained. FIGS. 3A and 3B are process charts showing the process for providing the film 14 to the convex sections 13 of the target substrate X.

Firstly, as shown in FIG. 1, the target substrate X is mounted on the mounting stage 120 of the evaporation apparatus 100 in the state of being tilted a predetermined angle θ with respect to the perpendicular of the mounting stage 120. In this case, the target substrate X is disposed so that the straight line connecting the mounting stage 120 and the crucible 130 and the extending direction of the convex sections 13 intersect with each other. In the present embodiment, the target substrate X is disposed so that the straight line connecting the mounting stage 120 and the crucible 130 and the extending direction of the convex sections 13 are substantially perpendicular to each other.

Subsequently, the first film material 140 is evaporated by the crucible 130 to deposit the particle of the film material 140 on one side surface 13a of each of the convex sections 13 to thereby form a first film 14a as shown in FIG. 3A.

In FIG. 3A, the arrows D1 indicate the direction (a first direction) in which the particles of the first film material 140 flying to the one side surface 13a. The first direction is preferably a direction intersecting with the extending direction of the convex sections 13. In the present embodiment, the first direction in which the particles of the first film material 140 fly thereto is substantially perpendicular to the extending direction of the convex sections 13. Further, the first direction is arranged to be a direction traversing the convex section 13 from the side surface 13a on one end X1 side of the target substrate X to the side surface 13b on the other end X2 side out of the both side surfaces 13a, 13b of each of the convex sections 13 in the direction along the shorter dimension of each of the convex sections 13.

Here, as shown in FIG. 1, there is a difference in the distance (e.g., between the distance L1 and the distance L2) from the first film material 140 between the convex sections 13 of the film forming surface Xa of the target substrate X. Due to the difference in the distance from the first film material 140, namely the difference in the location in the film forming surface Xa of the target substrate X between the convex sections 13, there is caused unevenness of the amount of deposition of the particles of the first film material 140. Specifically, the amounts of the particles of the first film material 140 deposited on the convex sections 13 ascend toward the one end X1 of the target substrate X with the shorter distance from the first film material 140, and descend toward the other end X2 with the longer distance therefrom.

Therefore, as shown in FIG. 3A, the volumes of the first films 14a formed on the surfaces of the respective convex sections 13 ascend toward the one end X1 of the target substrate X, and descend toward the other end X2 thereof. Therefore, the film thicknesses of the first films 14a ascend toward the one end X1 of the target substrate X, and descend toward the other end X2, thus causing the unevenness of the film thickness of the first film 14a.

In the present embodiment, the target substrate X is reversed after forming the first film 14a to rearrange the target substrate X on the mounting stage 120 so that the one end X1 of the target substrate X is located on the mounting stage 120 side and the other end X2 thereof is located on the first film material 140 side. Further, a second film material 150 is disposed on the crucible 130.

Subsequently, the second film material 150 is evaporated by the crucible 130 to deposit the particle of the second film material 150 on the other side surface 13b of each of the convex sections 13 to thereby form a second film 14b as shown in FIG. 3B.

In FIG. 3B, the arrows D2 indicate the direction (a second direction) in which the particles of the second film material 150 flying to the other side surface 13b. The second direction is preferably a direction intersecting with the extending direction of the convex sections 13. In the present embodiment, the second direction in which the particles of the second film material 150 fly thereto is substantially perpendicular to the extending direction of the convex sections 13. Further, the second direction is arranged to be a direction traversing the convex section 13 from the side surface 13b on the other end X2 side of the target substrate X to the side surface 13a on the one end X1 side out of the both side surfaces 13a, 13b of each of the convex sections 13 in the direction along the shorter dimension of each of the convex sections 13.

Here, similarly to the case of forming the first film 14a, there is a difference in the distance from the second film material 150 between the convex sections 13 of the film forming surface Xa of the target substrate X (see FIG. 1). Therefore, similarly to the case of the first films 14a, the amounts of the particles of the second film material 150 deposited on the other side surfaces 13b of the respective convex sections 13 ascend toward the other end X2 of the target substrate X with the shorter distance from the second film material 150, and descend toward the one end X1 thereof with the longer distance.

Therefore, as shown in FIG. 3B, the volumes of the second films 14b formed on the surfaces of the respective convex sections 13 ascend toward the other end X2 of the target substrate X, and descend toward the one end X1 thereof. Therefore, the film thicknesses of the second films 14b ascend toward the other end X2 of the target substrate X, and descend toward the one end X1, thus causing the unevenness of the film thickness of the second film 14b.

In other words, by depositing the second film material 150 on each of the convex sections 13 in the second direction different from the first direction in which the first film material 140 is deposited thereon after forming the first film 14a, the second films 14b having the unevenness in film thickness different from the unevenness in film thickness of the first film 14a are formed on the surface of each of the convex sections 13. Through the process described above, as shown in FIG. 4, the polarization element 10 provided with the convex sections 13 forming the stripes and the films 14 each having a thin line shape can be formed.

The films 14 are formed on at least the entire surface of the area in which the polarization element 10 is formed in the target substrate X. In the embodiment of the present invention, the evaporation of aluminum is performed while depressurizing the inside of the chamber 110 to 6.7×10⁻³ Pa, and at a deposition rate of 824 nm/min. As a method of forming the films 14, any method capable of performing the deposition in an oblique direction with respect to the film forming surface Xa of the target substrate X can be applied besides the evaporation method, and an oblique deposition method such as a magnetron sputtering method, an ion-beam sputtering method, or an opposed target sputtering method can also be applied in addition thereto.

In the present embodiment, aluminum is used as the first film material 140 and the second film material 150 as the constituent material of the films 14. Therefore, in practice, it is not required to interchange the first film material 140 and the second material 150 each other. As the first film material 140 and the second film material 150, silicon, germanium, and molybdenum can preferably be used besides aluminum. If aluminum is used as the constituent material of the films 14, although it is worked easily, since aluminum is a metallic material apt to be oxidized, it might be deteriorated.

Therefore, it is preferable to use silicon, germanium, or molybdenum, which are hard to be oxidized, among the metallic materials and the half-metallic materials described above, because the films 14 can be made hard to be deteriorated. For example, when the polarization element is used in an application in which the temperature thereof becomes high, although the oxidation reaction is accelerated under the high temperature environment, by forming the films 14 using the materials described above, it becomes possible to make the polarization element highly durable. Further, it is also possible to use alloys mainly containing these materials as the constituent material if necessary.

In the present embodiment, by making the first direction in which the first film material 140 is deposited and the second direction in which the second film material 150 is deposited different from each other, the unevenness of the film thickness of the second film 14b becomes opposite to the unevenness of the film thickness of the first film 14a. Therefore, it becomes possible to cancel the unevenness of the film thickness of the first film 14a with the unevenness of the film thickness of the second film 14b to thereby uniformize the film thickness of the film 14 composed of the first film 14a and the second film 14b.

Therefore, according to the method of manufacturing the polarization element of the present embodiment, it becomes possible to form the films 14 with uniform film thickness each composed of the first film 14a and the second film 14b on the surfaces of the respective convex sections 13 to thereby manufacture the polarization element expressing the optical solid state properties more uniform than those in the related art.

Further, in the present embodiment, the plurality of convex sections 13 is provided to form stripes, and the first direction intersects with the extending direction of the convex sections 13 so as to traverse each of the convex sections 13 from the one side surface 13a of each of the convex sections 13 in the direction along the shorter dimension thereof to the other side surface 13b thereof. Further, the second direction intersects with the extending direction of the convex sections 13 so as to traverse each of the convex sections 13 from the other side surface 13b to the one side surface 13a.

Therefore, it becomes possible to deposit the first film material 140 on the side surface 13a of each of the convex sections 13 in the direction along the shorter dimension thereof. Further, it becomes also possible to deposit the second film material 150 on the side surface 13b of each of the convex sections 13 in the direction along the shorter dimension thereof. Thus, as shown in FIG. 4, it becomes possible to form the films 14 each shaped like a thin line and composed of the first film 14a and the second film 14b so as to straddle the both side surfaces 13a, 13b of the striped convex sections 13.

Further, in the direction intersecting with the extending direction of the convex sections 13, the gradient of the variation in the film thickness of the first films 14a at respective locations on the film forming surface Xa becomes opposite to the gradient of the variation in the film thickness of the second films 14b at the respective locations on the film forming surface Xa. Thus, it becomes possible to form the films 14 with the uniform film thickness composed of the first films 14a and the second films 14b on the surfaces of the respective convex sections 13.

Further, in the present embodiment, after forming the first films 14a, the target substrate X is reversed, and then the second films 14b are formed. Therefore, as shown in FIG. 1, it becomes possible to dispose the first film material 140 and the second film material 150 on the same side (in substantially the same direction) with respect to the target substrate X, to deposit the first film material 140 and the second film material 150 on the convex sections 13 in the directions opposite to each other to thereby form the first films 14a and the second films 14b in the direction different from each other.

The uniformization of the film thickness of the films 14 will hereinafter be explained in further detail with reference to FIGS. 5 through 12.

As shown in FIG. 5, it is assumed that a material source of the film material is S, the film forming surface of the substrate is P, the distance between the material source S and the film forming surface P is R₀, the origin of the normal line when disposing the material source S in the normal direction of the film forming surface P is O, an infinitesimal area element at a point Q on the film forming surface P with a distance x from the origin O is dσ, and the distance between the material source S and the point Q is R. A solid angle dω when viewing the infinitesimal area element dσ from the material source S is expressed by the formula 1 below.

dω=dσ·cos θ/R² (1)

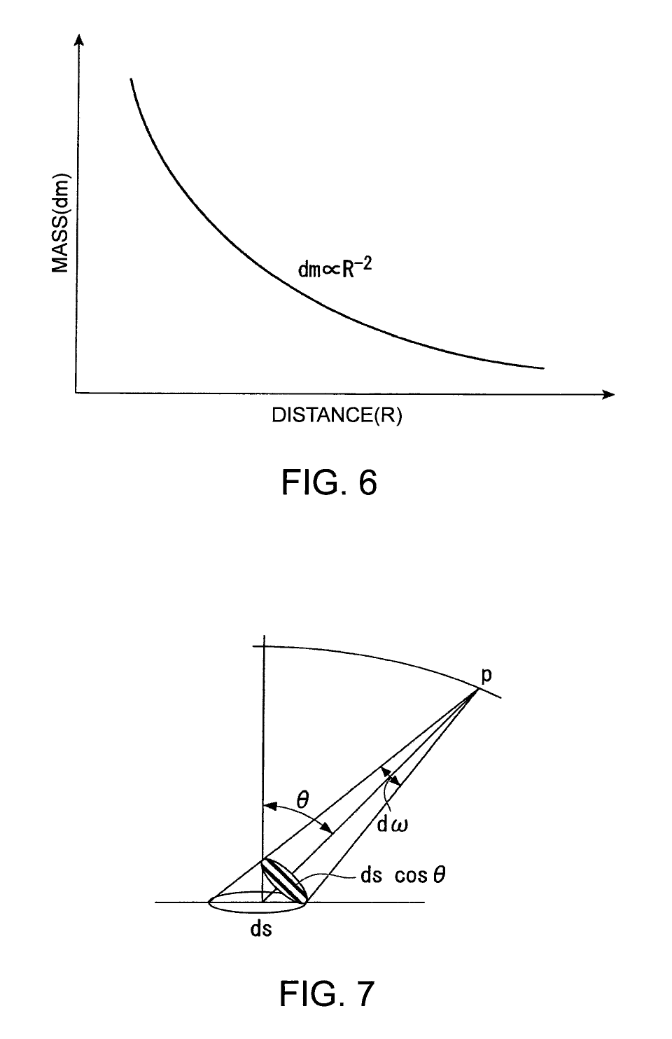

Assuming that the mass of the film material included in the area corresponding to the solid angle dω among the total mass m of the film material evaporated from the material source S is dm, the mass dm is expressed by the formula 2 below. Specifically, as shown in FIG. 6, the mass dm is inversely proportional to the square of the distance R. The mass dm can also be reworded as an amount of deposition (the film thickness) or a deposition rate. Therefore, it is also possible to say that the deposition rate on the film forming surface P is inversely proportional to the square of the distance R from the material source S.

dm=m·dσ·cos θ/4πR² (2)

In the case in which the material source S is an infinitesimal plane, it is possible to consider the following by taking the angle distribution along the cosine theorem into consideration. In FIG. 7, an arbitrary point p on a spherical surface with a sufficiently large radius centered on an infinitesimal plane ds is considered. Assuming that the solid angle centered on the point p and including the infinitesimal plane ds is dω, since the radiation from each point on the infinitesimal plane ds has a random angle distribution, the number of molecules started from the infinitesimal plane ds toward the point p is proportional to the solid angle dω. Assuming that the angle formed between the perpendicular of the infinitesimal plane ds and the direction toward the point p is θ, the solid angle dω is expressed by the formula 3 below.

dω=ds·cos θ/R² (3)

Therefore, the evaporation from the infinitesimal plane ds shows an angle distribution of cos θ with respect to the direction at the angle θ with the normal line of the infinitesimal plane ds. The film thickness distribution on the film forming surface P disposed in parallel with the infinitesimal plane ds as the evaporation source can be obtained in the similar manner to the case of the material source S as a point source, assuming that the infinitesimal plane ds perpendicular to the perpendicular OS is located at the position of the material source S in FIG. 5. Specifically, the mass dm is expressed by the formula 4 below. In practice, the film material in the evaporation process and the target in the sputtering process both can be regarded as the infinitesimal plane ds.

dm=m·ds·cos θ/πR² (4)

In other words, even in the case in which the material source S is an infinitesimal plane, the mass dm is inversely proportional to the square of the distance R.

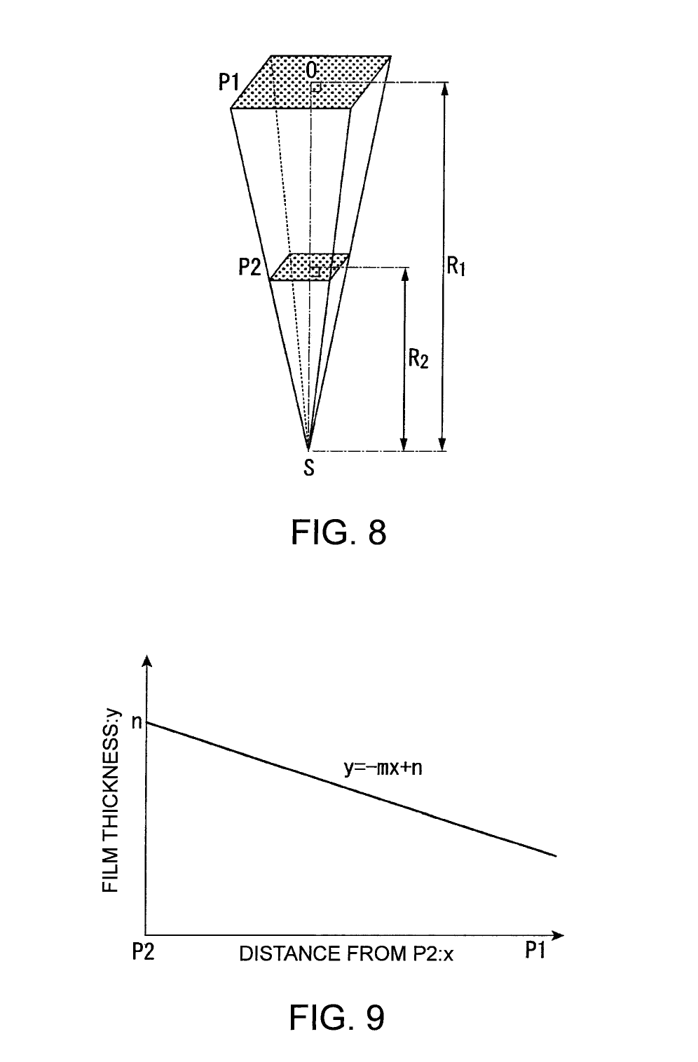

Then, as shown in FIG. 8, the amounts of deposition in the film forming surfaces P1, P2 on the normal line passing through the material source S are compared to each other. As described above, the amount of deposition is inversely proportional to the square of the distance from the material source. However, in the case in which the distance between the film forming surface P1 and the film forming surface P2 is extremely small with respect to the distance R1 between the material source S and the film forming surface P1, the film thickness distribution between the film forming surface P1 and the film forming surface P2 after the evaporation can be approximated by a linear function as shown in FIG. 9. In this case, the amount of deposition on the film forming surface P2 closer to the material source S is large, and the amount of deposition on the film forming surface P1 further from the material source S is small.

For example, in the case in which one surface of a 12-inch square silicon wafer is used as the film forming surface, and SiO₂ is evaporated as the film material, the length (the distance from one end to the other end) of a side of the film forming surface is not larger than 10 cm with respect to the distance of 200 cm between the evaporation source and the film forming surface. Therefore, the difference in the distance from each point of the film forming surface to the evaporation source with respect to the distance from the evaporation source to the film forming surface becomes extremely small. Therefore, in the film thickness distribution in the film forming surface of the substrate, the approximation to the linear function shown in FIG. 9 becomes true.

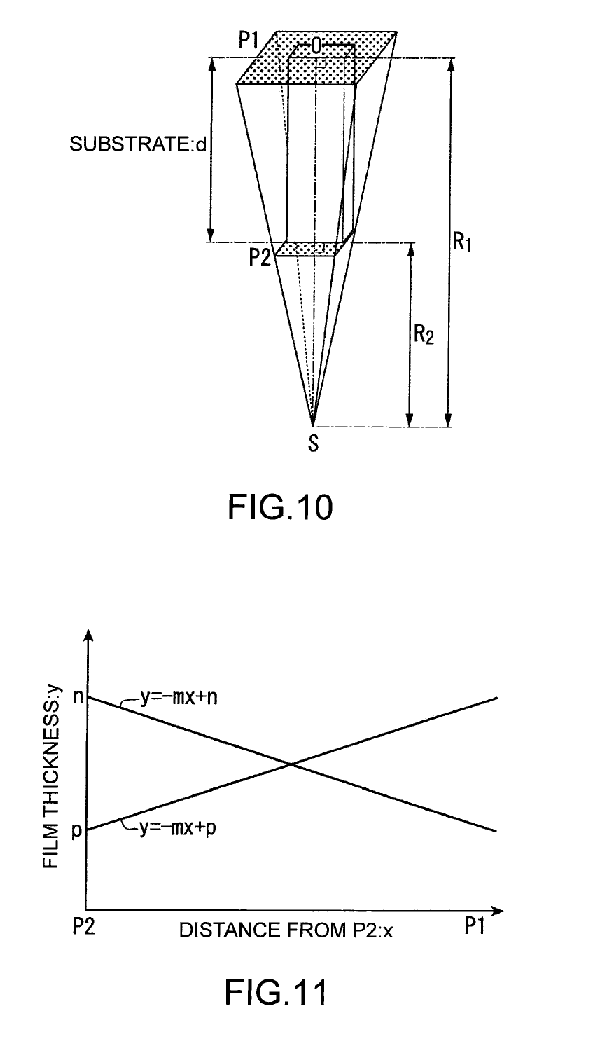

Here, as shown in FIG. 10, in the case of disposing a substrate with a length of d between the film forming surfaces P1, P2, the variation in the film thickness in the film forming surface of the substrate can be considered in the similar manner to the case of the film thickness distribution shown in FIG. 9.

It is assumed that as a result of the performance of the first evaporation on the film forming surfaces of the substrate disposed as described above, the film thickness distribution shown in FIG. 9 is caused between the film forming surfaces P1, P2. In order for uniformizing the film thickness distribution, it is required to perform the second evaporation from the second direction different from the first direction in which the first evaporation is performed. More specifically, the second direction is preferably opposite to the first direction viewed from the film forming surface of the substrate. In other words, it is preferable that the first direction and the second direction are symmetrical to each other with respect to the normal line of the film forming surface of the substrate. Further, it is preferable that the first direction and the second direction have the same angle with the film forming surface, and are the directions facing straight when being projected on the film forming surface of the substrate.

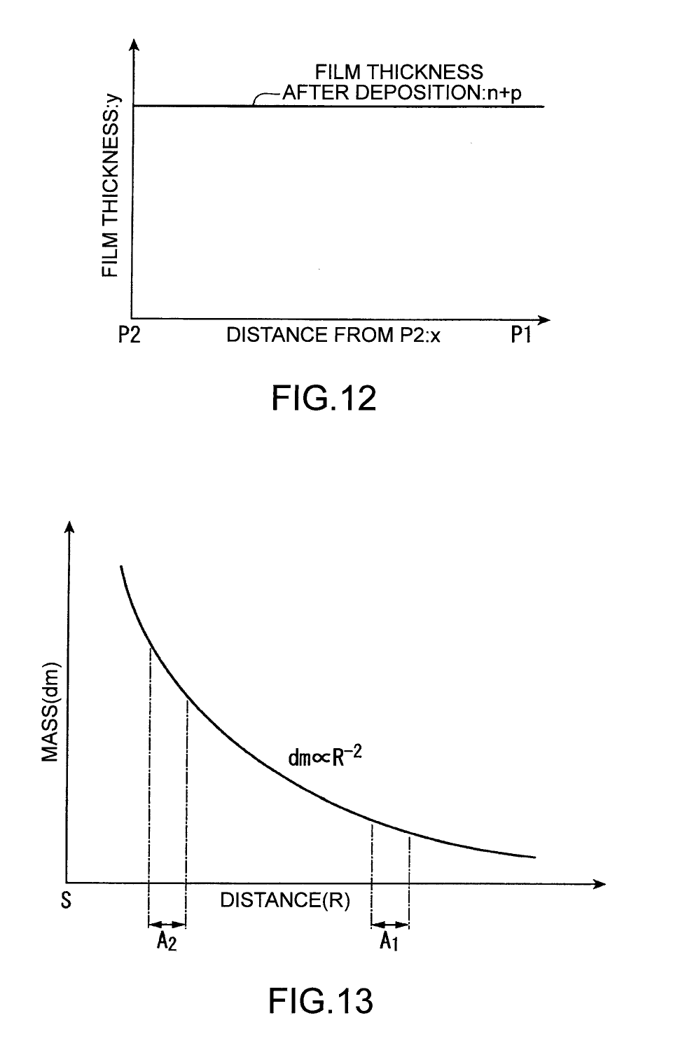

As described above, by performing the second evaporation from the second direction different from the first direction in which the first evaporation is performed, more preferably the second direction opposite to the first direction, it becomes possible to make the film thickness distribution (the approximation formula: y=—mx+n) of the first evaporation and the film thickness distribution (the approximation formula: y=mx+p) of the second evaporation have the gradients opposite to each other as shown in FIG. 11. Further, the film thickness distribution of the film composed of the first film formed by the first evaporation and the second film formed by the second evaporation is uniformized by adding the film thickness distributions of the first film and the second film to each other as shown in FIG. 12.

Then, the variation of the film thickness of the film in the film forming surface due to the variation in the distance from the evaporation source to the film forming surface will be explained in detail.

As described above, the mass dm (the amount of deposition, the film thickness, or the deposition rate on the film forming surface P) of the particles flying from the material source S shown in FIG. 5 to the film forming surface P is represented by the formula 2 mentioned above. According to this formula 2, in the case in which the distance between the film forming surfaces P1, P2 is sufficiently small with respect to the distance R1 between the material source S and the film forming surface P1 shown in FIG. 10, the variation in the film thickness (the mass dm) in the film forming surface P in the area A1 with longer distance R from the material source S is smaller than that in the area A2 with shorter distance R as shown in FIG. 13.

In other words, as shown in FIG. 13, the mass dm is inversely proportional to the square of the distance R, and the variation in the mass dm becomes smaller in the side with the longer distance from the material source S where the absolute value of the gradient of “mass dm/distance R” becomes smaller. It should be noted that the deposition rate decreases in an exponential manner as the distance R from the material source S becomes longer. Therefore, in the case of the evaporation (evaporation pressure: 1.0×10⁻³ Pa), the distance R is preferably not larger than 300 cm. Further, in the case of forming the film by a sputtering method (sputtering pressure: 1.0×10⁻¹ Pa) using, for example, an opposed target sputtering apparatus, the distance R is preferably not larger than 30 cm.

Then, the relationship between the angle of the film forming surface of the substrate with respect to the normal direction of the evaporation source and the variation in the amount of deposition will be explained in detail.

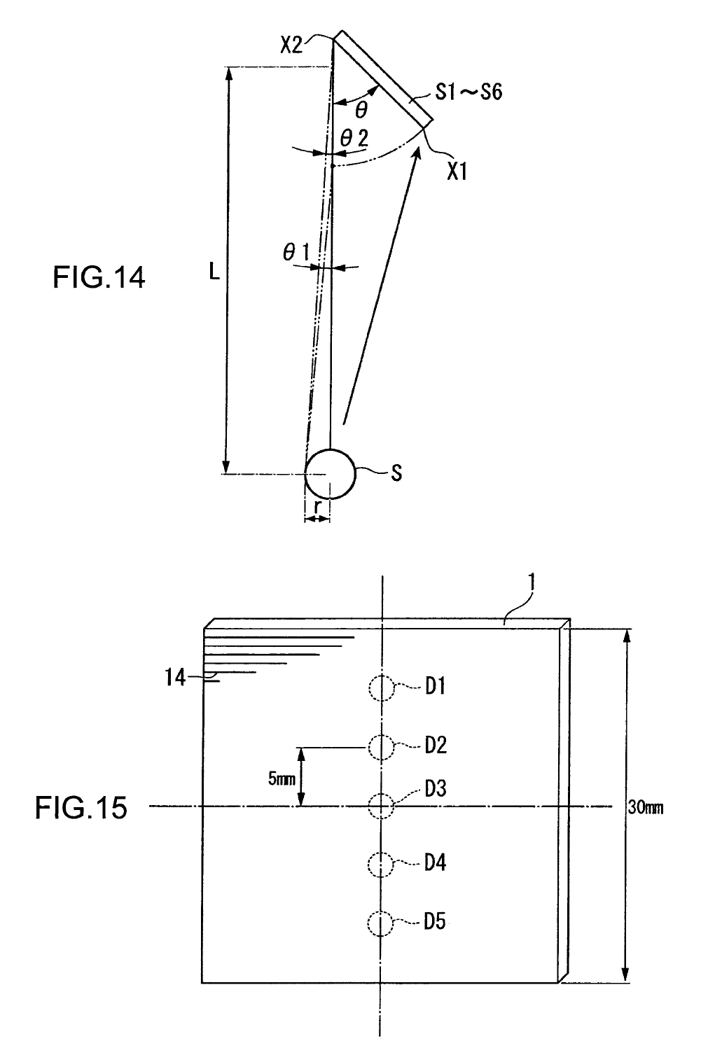

Firstly, 30 mm square substrates S1 through S6 were prepared, then the first film material was deposited in the first direction to thereby form the first film on the convex sections of the film forming surface with the angle θ of the film forming surface with respect to the normal direction of the material source S shown in FIG. 14 and the deposition rate different between the substrates S1 through S6. The deposition conditions corresponding to the respective substrates S1 thorough S6 are shown in Table 1.

TABLE 1

| SUBSTRATE | ANGLE θ | DEPOSITION RATE |
|---|---|---|
| S1 | 60° | HIGH |
| S2 | 60° | LOW |
| S3 | 30° | HIGH |
| S4 | 30° | LOW |
| S5 | 0° | HIGH |
| S6 | 0° | LOW |

Subsequently, as shown in FIG. 15, the cross section measurement using SEM observation was performed at 5 points (the symbols D1 through D5) along the first direction intersecting with the extending direction of the first film in each of the substrate S1 through S6 to thereby measure the amount of deposition (the film thickness) of the first film at each of the measurement points. The constant intervals of 5 mm are provided between the measurement points. Here, it is arranged that the measurement point D1 has the longest distance L from the material source S, and the measurement point D5 has the shortest distance L from the material source S.

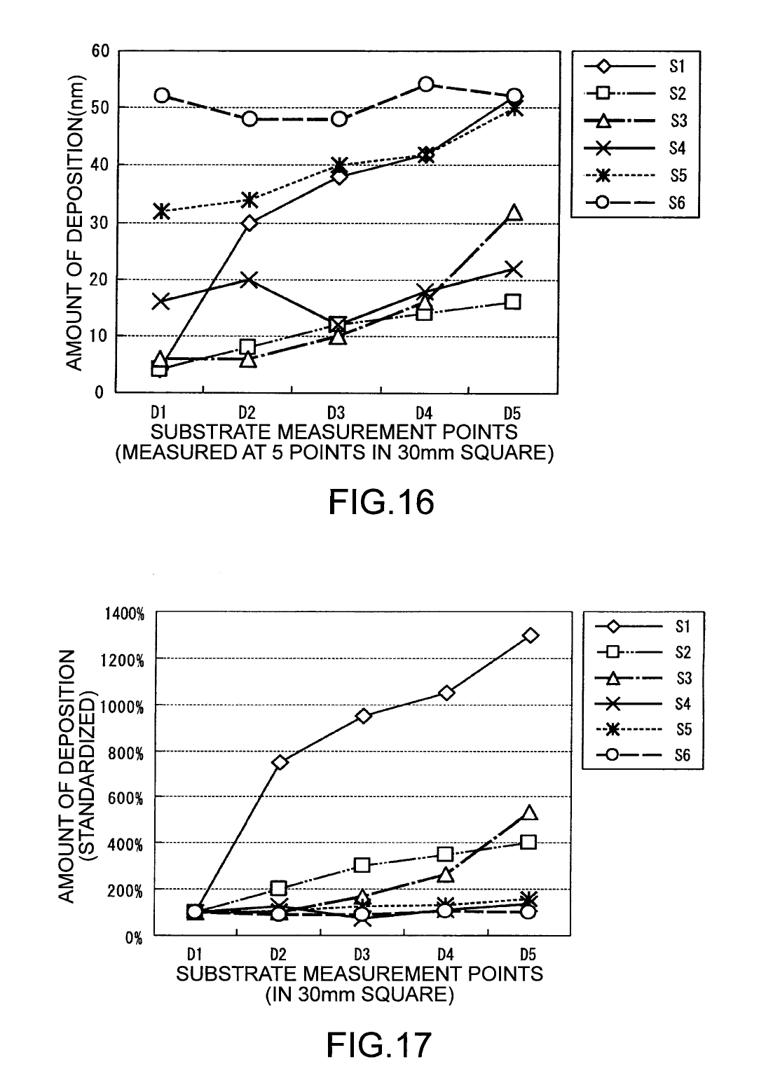

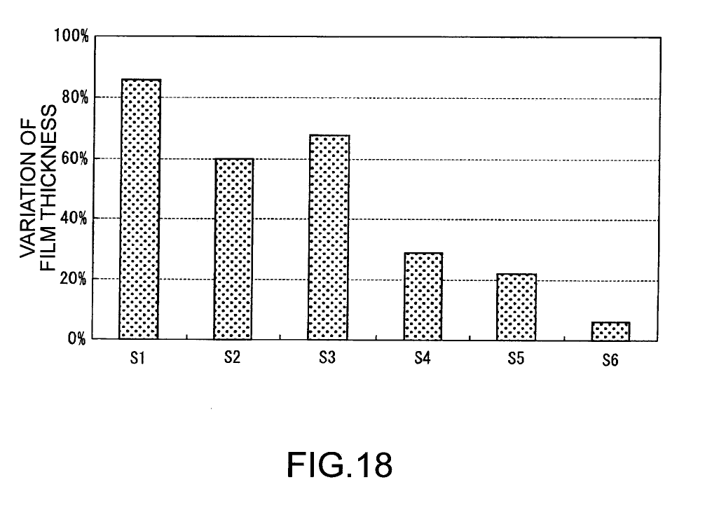

FIG. 16 is a graph showing a result of the measurement of the amount of deposition. FIG. 17 is a graph representing the amount of deposition at each of the measurement points D1 through D5 standardized assuming that the amount of deposition at the measurement point D1 of each of the substrates S1 through S6 is 100%. FIG. 18 is a graph showing the variation in the film thickness of each of the substrates S1 through S6.

As shown in FIGS. 16 through 18, there is a tendency that the larger the angle θ is and the higher the deposition rate is, the larger the variation in the film thickness at the measurement points D1 through D5 becomes. Therefore, in order for forming the film on the film forming surface of the substrate more uniformly, it is desirable that the angle θ of the substrate is 0°.

Here, it is assumed that in the case in which the angle θ of the substrate is 0°, the radius of the material source S is r, the angle formed between the straight line connecting the outer frame of the material source S and the one end X1 of the substrate and the normal line passing through the center of the material source S is θ1, and the angle formed between the straight line connecting the outer frame of the material source S and the other end X2 of the substrate and the normal line passing through the center of the material source S is θ2. In this case, the distance L between the material source S and the substrate, and the radius r of the material source S are selected so that the angle θ2 becomes smaller than 5°, preferably not smaller than 2° and not larger than 3°. By adopting such a configuration, it becomes possible to neglect the difference in the angle between the angle θ1 of the one end X1 of the substrate and the angle θ2 of the other end X2. Thus, it becomes possible to form a film with more uniform film thickness on the substrate.

It should be noted that the present invention is not limited to the embodiments described above, but can be modified in various manners in practical use within a scope or spirit of the invention. For example, although in the manufacturing method of the polarization element explained in the embodiment described above, the evaporation apparatus is used as the manufacturing apparatus of the polarization element, it is also possible to use a normal sputtering apparatus or an opposed target sputtering apparatus instead of the evaporation apparatus. Further, in the case of using the opposed target sputtering apparatus, it is also possible to perform the deposition while conveying the substrate in the direction intersecting with the flying direction of the film material particles. Thus, it becomes possible to uniformize the film thickness in the conveying direction of the substrate.

Further, in the case of using the sputtering apparatus, it is preferable to arrange the substrate and the sputtering apparatus so that angle formed between the flowing direction of the plasma flow and the film forming surface of the substrate becomes smaller than 5°, preferably not smaller than 2° and not larger than 3°. By adopting such an arrangement, it becomes possible to neglect the angle difference between the angle between the plasma flow of the one end of the substrate and the film forming surface, and the angle between the plasma flow of the other end of the substrate and the film forming surface. Thus, it becomes possible to form a film with more uniform film thickness on the substrate.

What is claimed is:

1. A method of manufacturing a polarization element, adapted to form a film at least on a part of a surface of a plurality of convex sections provided to at least one surface of the substrate, the method comprising:
(a) depositing a first film material on the one surface of the substrate in a first direction to thereby form a first film on the convex section; and
(b) depositing a second film material in a second direction different from the first direction to thereby form a second film on the convex section.

2. The method of manufacturing a polarization element according to claim 1, wherein
the plurality of convex sections is disposed in a striped manner, and
the first direction and the second direction intersect with an extending direction of the convex sections.

3. The method of manufacturing a polarization element according to claim 2, wherein
the first direction is a direction traversing the convex section from one side surface of both of side surfaces of the convex section in a direction along a shorter dimension of the convex section to the other side surface, and
the second direction is a direction traversing the convex section from the other side surface to the one side surface.

4. The method of manufacturing a polarization element according to claim 1, further comprising:
(c) reversing the substrate,
wherein step (c) is performed between steps (a) and (b).
